(19) United States
(12) Patent Application Publication
(10) Pub. No.: US 2018/0290907 A1
(43) Pub. Date: Oct. 11, 2018

(54) BLUE-OXYGEN ORAL CARE MACHINE

(71) Applicant: Bluecare North America Inc., Brooklyn, NY (US)

(72) Inventors: Ying Zi Guo, Brooklyn, NY (US); Kai Dan Mai, Brooklyn, NY (US)

(73) Assignee: Bluecare North America Inc., Brooklyn, NY (US)

(21) Appl. No.: 15/683,779

(22) Filed: Aug. 23, 2017

(30) Foreign Application Priority Data
Apr. 11, 2017 (CN) 201710232204
Apr. 11, 2017 (CN) 201720372878

(51) Int. Cl. C02F 1/78; A46B 11/00; C25B 1/13

(52) U.S. Cl. CPC C02F 1/78; C02F 2103/026; C25B 1/13; A46B 11/0072

(57) ABSTRACT

Disclosed herein is an oral care machine including: a tank for storing water; an ozone generator for generating ozone, the ozone generator mounted in the tank, wherein generated ozone mixes with water stored in the tank; a processing cartridge for treating exhaust gas of ozone generated by the machine when ozone is mixed with water, the processing cartridge mounted on the tank; a water pump for transporting treated water; and a handle for delivering the treated water to a desired location.

### BACKGROUND

### Field of the Invention

Embodiments of the present invention are generally related to cleaning appliances. More particularly, embodiments of the present invention are related to a blue-oxygen oral care machine for creating ozone water for cleaning.

### Description of the Related Art

In today's world, water sources for human consumption or other uses, such as in dentistry, can often contain contaminants and various pollution elements such as living organisms (bacteria, viruses, or the like) and organic and inorganic substances causing unwanted odor and color. These contaminants may also make the water potentially unsafe or harmful for the human, animal, or plant consuming the water. As such, it is desired to reduce the amount of contaminants in water to improve safety of consumption. One method of reducing and/or eliminating contaminants in water is to treat the water with ozone, or “blue-oxygen,” creating an “ozone water.”

Ozone water is rich in oxygen and by use of various trace elements in water, it can effectively kill bacteria and disease such as E. coli, gonococcal, Salmonella, Mycobacterium tuberculosis, and other bacterium viruses. Ozone water is a high quality drinking water. Ozone water is beneficial in many other applications as well, such as cleaning.

One drawback of ozone water, however, is that in the preparation of ozone water, ionization equipment generated by the ozone will inevitably be partially emitted into the surrounding ambient air, or the like. Ozone emitted into indoor areas may cause a negative effect on the health of people or animals in the surrounding area, and may produce an undesirable pungent odor. In addition to the health risk associated with released ozone into the air, the ozone water creation process is often prohibitively expensive for a consumer.

Thus, there is a need for an improved machine that will reduce and/or eliminate the health risk to the user and in a more affordable design.

### SUMMARY

Embodiments of the present invention are generally related to cleaning appliances. More particularly, embodiments of the present invention are related to a blue-oxygen oral care machine for creating ozone water for cleaning.

According to an exemplary embodiment of the present invention, there is provided a oral care machine comprising: a tank for storing water; an ozone generator for generating ozone, the ozone generator mounted in the tank, wherein generated ozone mixes with water stored in the tank; a exhaust ozone gas heater/processing cartridge for treating exhaust gas of ozone generated by the machine when ozone is mixed with water, the exhaust ozone gas heater/processing cartridge mounted on the tank; a water pump for transporting treated water; and a handle for delivering the treated water to a desired location

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 is a schematic diagram of a structure in accordance with embodiments of the present disclosure;

FIG. 2 is an illustration of perspective view of an oral care blue water oxygen machine in accordance with embodiments of the present disclosure;

FIG. 3 is an illustration of a perspective view of an oral care blue water oxygen machine in accordance with embodiments of the present disclosure;

FIG. 4 is an illustration of an exploded view of a blue aqueous oral care machine oxygen tank section in accordance with embodiments of the present disclosure;

FIG. 5 is an illustration of an exploded view of a ionization apparatus in accordance with embodiments of the present disclosure;

FIG. 6 is a schematic diagram of a blue oxygen oral care system in accordance with embodiments of the present disclosure; and

FIG. 7 is a schematic diagram of a blue oxygen oral care system in accordance with embodiments of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Technical configurations and acting effects of a blue-oxygen oral care machine in accordance with embodiments of the present disclosure will be clearly understood by the following detailed description provided with reference to the accompanying drawings in which exemplary embodiments of the present invention are illustrated. As used herein, the term “ozone water” may generally refer to blue oxygenated water. As used herein “blue-oxygen” may generally refer to ozone, an inorganic molecule with the chemical formula O₃, or the like. Embodiments of the present invention are generally related to cleaning appliances. More particularly, embodiments of the present invention are related to a blue-oxygen oral care machine for creating ozone water for cleaning.

Embodiments of the present disclosure include an oral care machine that provides blue oxygenated water, or the like. To achieve the result of safe, blue oxygenated water, the present invention provides an oral care machine that creates blue-oxygen water utilizing an exhaust ozone gas heater/ozone exhaust processing cartridge. The machine may include a tank, an ozone generator, a water pump, and/or the like. The machine may produce ozone and mix the ozone with water in a water tank. An ozone tailing treatment cartridge may be designed, formed, and/or manufactured to treat ozone offsets generated when ozone is mixed with water. The water pump may carry out the handling and pumping of the water. A handle may be used to receive ozone water and to clean, for example, a person's face and/or mouth.

A blue oxygen water oral-care machine in accordance with embodiments of the present disclosure may include an exhaust ozone gas heater/an ozone exhaust processing cartridge, a water tank, an ionization device, a pump, a handle, and/or the like. The ozone exhaust processing cartridge may be mounted at the upper side of the water tank and connected to an upper space of the tank. An ionizing device may be mounted inside the water tank and may generate ozone within the water tank, or the like. A water tank, pump, and handle may be connected to each other via tubing, and/or the like. A blue-oxygen water machine in accordance with exemplary embodiments may include an oral-care flossing head, and/or the like. When cleaning teeth gaps, a blue-oxygen machine can inject or disburse ozone water, not only to remove residues between the teeth, but also oral sterilizing Some benefits of a machine in accordance with exemplary embodiments are absorbing excess ozone gas, avoiding ozone emissions into the room thereby preventing air pollution and damage to consumer health, to name a few. It also may include different nozzle/head for cleaning the face, the mouth, or the like. The overall design may be user-friendly, convenient for consumer to carry around traveling, and include unique features as described herein and contemplated by and within embodiments of the present disclosure.

In exemplary embodiments an exhaust ozone gas heater/exhaust processing cartridge is mounted to an upper end of the tank and an ionizing means is mounted in the tank for generating ozone within the water tank the tank. A pump and line are sequentially connected using the handle, or the like. An ionizing device comprises a tank cover shield sheet, electrolysis plate, an electrolyte sheet, a tank cap seal, an electrolysis sheet, a water receiving tank cover, and/or the like. An upper electrolytic sheet and a lower electrolytic sheet may respectively be mounted on an upper and lower end of a water tank sealing ring, or the like. In some embodiments, the water tank sealing ring may be mounted on the water tank cover and fixed to the electrolytic plate pressing plate, or the like. In exemplary embodiments, a machine may include an electrolytic sheet pressing plate and an upper electrolytic sheet. A plurality of through holes 21, 22 may be present in the water tank cover protector 14, connect with each other to form a water passage, and the water tank cover shield may be mounted on the electrolytic plate and cover the water passage. A water tank cover may be provided with a plurality of fine filter holes, and the water tank cover may be connected with the water receiving end, or the like.

A machine may further include an accessory box, the box comprising a rotatable accessory is in the machine side surface of a rotatable door. Further, the rotatable accessory case may be provided with an ultraviolet light source. The ultraviolet light source may be used for sanitation of an accessory, or other sutable use in accordance with exemplary embodiments. A machine may include a plurality of functional replacement connectors, which can be mounted on a handle. Further, the functional replacement joint replacement head may include a dental floss, rinse cleansing, and face replacement accessory or joint. The machine may comprise a rotatable joint replacement accessory holder box with dental floss, rinse cleansing and face replacement accessories that may be stored in a base, or the like.

The machine may be powered by a power source. The power source may include a corded AC connection, a battery, or a suitable power source in accordance with exemplary embodiments. In some embodiments, a machine may comprise a lithium battery and a battery cover. A lithium battery may be mounted in a machine and a battery lid may be fixed to an ionizing device or means. A pump may be powered by a lithium battery, or the like. An electric toothbrush may be provided. A machine may be provided with an electric toothbrush base for fixing an electric toothbrush, wherein an electric toothbrush holder is provided with an electric toothbrush charging interface, or the like. In some embodiments, a charger is used for charging the lithium battery and the electric toothbrush.

An ionizing device may include a tank cover shield plate, an electrolyte sheet, tank cap seals, an electrolysis sheet, a water receiving tank cover, and/or the like. In some embodiments, an electrolyte sheet may be mounted to the electrolysis sheet, or the like. Upper and lower ends of a water tank sealing ring may be fixed on a water tank cover and may be fixed by the electrolytic plate pressing plate. A center area of the electrolytic plate, the upper electrolytic sheet, the water tank cover seal, and the lower electrolytic film may be arranged at the center of the water tank, or the like. A plurality of through holes may be connected to each other to form a water passage through the ionizing device, or the like. A water tank cover shield may be mounted on an electrolytic plate and may covers a water passage. A water tank cover may be provided with a plurality of small filter holes, and the water tank cover may be connected to a water receiving end, or the like.

In addition, a stirring device may be installed in the tank. In some embodiments, the tank may include an independent ozone generator, and the ozone generated by the ozone generator may be passed into a water tank and mixed by the stirring device. In some embodiments, a jet may be used to mix the ozone in to the water and achieve a mixture of ozone and water.

A blue oxygenated water machine in accordance with embodiments of the present invention may include an oral care head for flossing and cleaning the teeth in a slot where the ozone water can be injected or directed. A machine may remove residues between the teeth and also sterilize the area. In some embodiments, additional processing by the machine can effectively absorb excess ozone, to avoid ozone emissions into the room, so that indoor air pollution, damage to the health of consumers, may be avoided. In some embodiments, a machine is provided with wash nozzles for easy cleaning of the mouth and face, and the overall design is more user-friendly. A machine in accordance with exemplary embodiments may be relatively easy for consumers to travel to carry out, while still providing powerful and significant results.

Advantages and features of the present invention and technologies accomplishing them will become apparent from exemplary embodiments described in detail below with reference to the accompanying drawings. However, the present invention is not limited to exemplary embodiments set forth herein, but may be modified in various different forms. These exemplary embodiments may be provided in order to make the disclosure of the present invention complete and allow those skilled in the art to which the present invention pertains to completely recognize the scope of the present invention. Throughout the disclosure, like reference numerals denote like elements. Further, the ozone exhaust processing cartridge is detachably mounted on the water tank.

In the disclosure and the claims, terms such as “first”, “second”, “third”, “fourth”, and the like, if any, will be used to distinguish similar components from each other and be used to describe a specific sequence or a generation sequence, but is not necessarily limited thereto. It will be understood that these terms are compatible with each other under an appropriate environment so that exemplary embodiments of the present invention set forth herein may be operated in a sequence different from a sequence illustrated or described herein. Likewise, in the case in which it is described herein that a method includes a series of steps, a sequence of these steps suggested herein is not necessarily a sequence in which these steps may be executed. That is, any described step may be omitted and/or any other step that is not described herein may be added to the method.

In addition, in the disclosure and the claims, terms such as “left”, “right”, “front”, “rear”, “top”, “bottom”, “over”, “under”, and the like, if any, do not necessarily indicate relative positions that are not changed, but are used for explanation. It will be understood that these terms are compatible with each other under an appropriate environment so that exemplary embodiments of the present invention set forth herein may be operated in a direction different from a direction illustrated or described herein. A term “connected” used herein is defined as being directly or indirectly connected in an electrical or non-electrical scheme. Here, targets described as being “adjacent to” each other may physically contact each other, be close to each other, or be in the same general range or region, in a context in which the above phrase is used. Here, a phrase “in an exemplary embodiment” means the same exemplary embodiment, but is not necessarily limited thereto.

In addition, in the disclosure and the claims, terms such as “connected”, “connecting”, “linked”, “linking”, “coupled”, “coupling”, and the like, and various modifications of these terms may be used as the meaning including that one component is directly connected to another component or is indirectly connected to another component through the other component.

In addition, terms “module” and “unit” for components used in the present disclosure are used only in order to easily make the disclosure. Therefore, these terms do not have meanings or roles that distinguish from each other in themselves.

In addition, terms used in the present disclosure are for explaining exemplary embodiments rather than limiting the present invention. In the present disclosure, a singular form includes a plural form unless explicitly described to the contrary. Components, steps, operations, and/or elements mentioned by terms “comprise” and/or “comprising” used in the disclosure do not exclude the existence or addition of one or more other components, steps, operations, and/or elements.

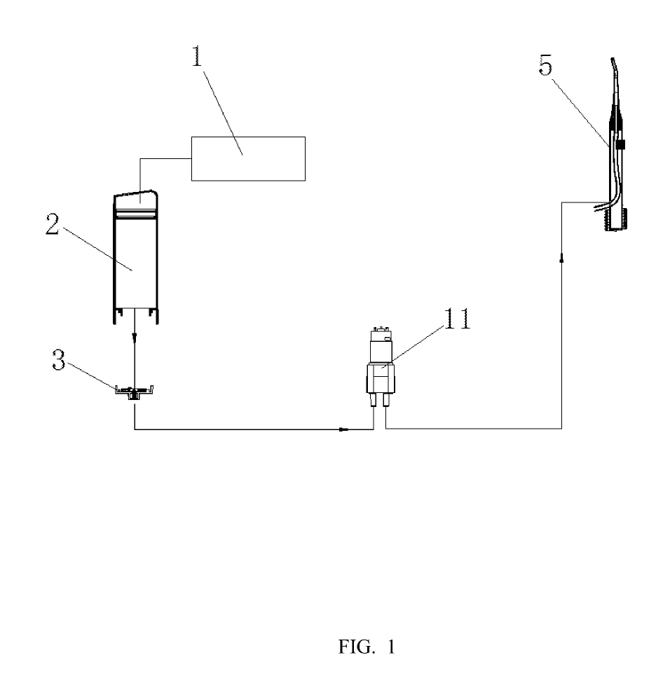

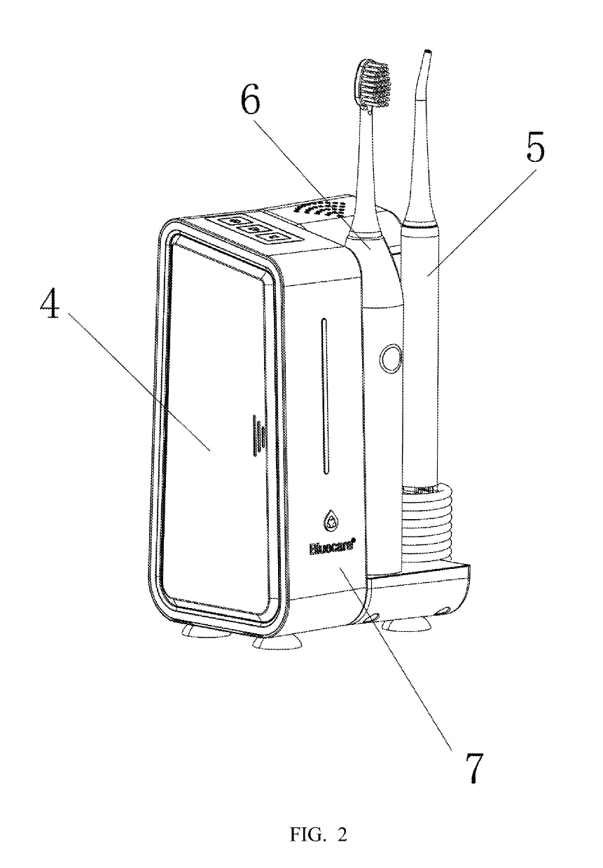

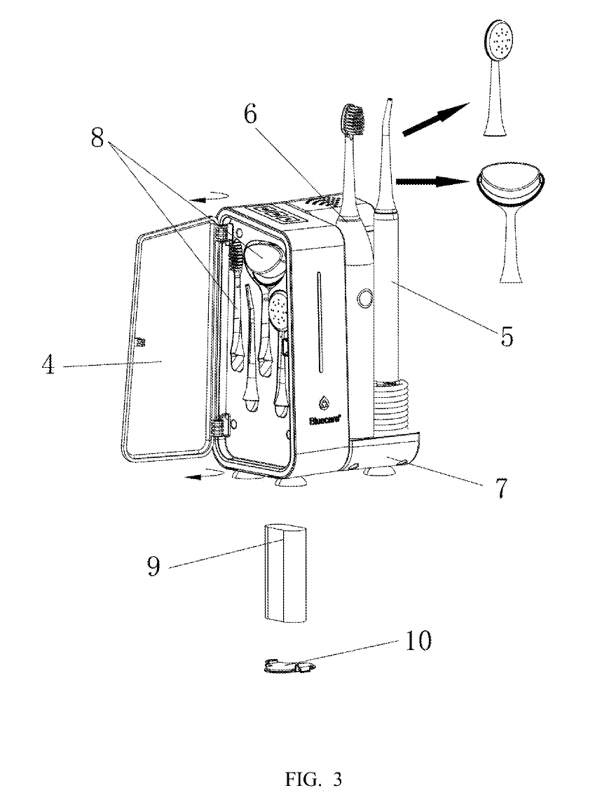

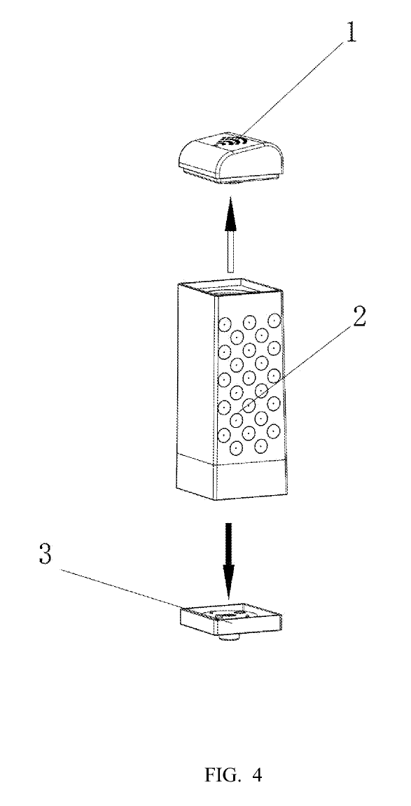

Referring to FIGS. 1-7, illustrations are provided that include a exhaust ozone gas heater/blue oxygen (ozone) exhaust processing cartridge 1, a water tank with a stirring device 2, a blue oxygen (ozone) generator ionizer 3, a storage compartment 4, an output handle with removable heads (attachments) 5, an electric toothbrush (optional) 6, a promotional logo 7, removable heads 8, a lithium battery (which can be substituted with an AC/DC transformer or power supply) 9, a battery cover 10, water pump 11, blue oxygen (ozone) generator ionizer 12, ejector device 13, a water tank cover/protector 14, an electrolytic sheet or plate 15, an upper electrolyte sheet or plate 16 of the electrolyte sheet, the seal ring or water tank cover seal 17 of the tank cover, an bottom electrolyzed sheet 18, a water tank cover 19, a water input connector 20 connected to the water, and/or the like. The structure of a blue-oxygen water according to embodiments of the present invention include an oral care machine shown in FIGS. 1, 2, 3, 4 and 5, comprising an ozone exhaust processing cartridge 1, a tank 2, an ozone generator, a water pump, and a handle 5. A machine in accordance with exemplary embodiments may include an ozone generator that provides ozone to be mixed with the water in the water tank 2.

Referring to FIGS. 1-4, 6, and 7, diagrams of structures in accordance with embodiments of the present disclosure are shown. An exhaust ozone gas heater or processing cartridge 1 for ozone off-gas exhaust ozone generated during the mixing process of water with ozone may be included. A water pump 11 for conveying the liquid may be included. The use of an output handle 5 which may have removable heads. For receiving water and ozone for cleaning the face, the oral cavity may be included. In some embodiments, the ozone generator 3 ionization apparatus and exhaust ozone gas heater/processing cartridge 1 are mounted to in or on the tank 2 on an upper end of the upper space of the tank 2. An ionizing device 3 is installed in the tank 2 and may work in conjunction with the exhaust ozone gas heater/processing cartridge 1 to eliminate and/or reduce excess ozone gas or emissions into the air. A water pump 11 may be connected to a handle 5 via tubing, or the like, which connects the handle to the ozone water, or the like.

An exhaust ozone gas heater 1 may include a lower end-cap, a middle housing, a heating element, and a upper end-cap assembly; the heating element assembly is mounted in the middle housing; the lower end-cap is mounted on the bottom of the middle housing; the upper end-cap mounted in the upper end of the middle housing. One side of the middle housing is provided with a second air-inlet port, the lower end-cap is provided with a second air-outlet port. The heating element assembly includes a heating lower cover, a heating element main unit, and a heating upper cover. The heating element main unit has a first air-inlet port and a first air-outlet port at the side, the heating main unit is provided with a first internal channel; one end of the first internal channel is connected with the first air-inlet port; and the other end is connected with the first air-outlet port; the heating lower cover and the heating upper cover are sealed and mounted at upper and bottom side of the heating element main unit. The first air-outlet port is connected with the second air-inlet port via small tube. The bottom side of the middle housing is also provided with a second channel, a catalyst disposed within said second channel, said second channel is connected to the second air-inlet port by one end, and connected the other end to the second air-outlet port.

The exhaust Ozone gas heater further comprises a seal gasket, the seal gasket is mounted between the lower end cap and the middle housing, the seal gasket is provided with the through holes and connected to the second air-outlet port. The exhaust ozone gas heater, wherein the heating element main unit comprises a first seal ring and a second seal ring, said first seal ring is mounted between the heating lower cover and the heating element main unit, the second seal ring is mounted between the heating upper cover and the heating element main unit. A temperature controller and a temperature fuse may be installed above the heating upper cover in the heating element unit. The upper and lower sides of the first channel may be connected with each other.

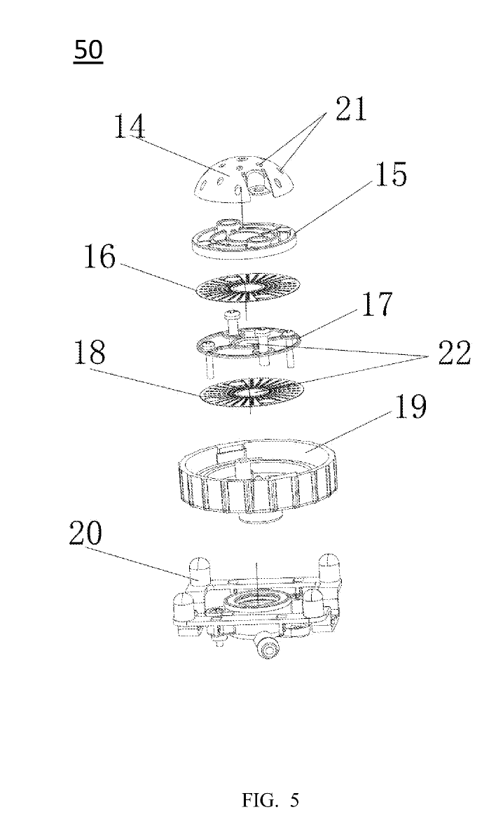

Referring to FIG. 5, an illustration of an exploded view of an ionization apparatus 50 in accordance with embodiments of the present disclosure is shown. An ionization apparatus 50 may comprise a tank cover segment 14, an electrolytic sheet plate 15, an upper electrolyte sheet 16, a water tank lid or cover seal 17, bottom electrolytic sheets 18, a water tank cover 19, and a water receiving tank cover end or water input connector 20. An upper electrolyte sheet 16 and lower or bottom sheet 18 may be attached to an electrolytic tank in the upper and lower ends of a water tank cover seal or seal ring 17. A sealing ring or water tank cover seal 17, or the like, may be mounted in the water tank cover 19 and electrolytic plate 15 or platen. An electrolyte sheet pressing plate 15, an upper electrolyte sheet 16, a sealing ring or water tank cover seal 17 and a bottom electrolyte sheet 18, or the like, may include through holes. Through holes may create a water passage through the water tank cover protector segment 14. The water tank cover segment 14 may be mounted on a plate 15 over the water passage. A water tank cover may be provided with a plurality of fine or smaller filtering holes. A tank cover 19 may be connected to a water receiving end or water input connector 20. Table 1 shows data from an example case in accordance with exemplary embodiments showing measurements of ozone concentration in water (mg/L).

TABLE 1

| | Electrolysis of water | | | |
|---|---|---|---|---|
| | experiment | experiment | experiment | |
| | one | two | three | average value |
| 0 | 0 | 0 | 0 | 0 |
| 1 | 0.25 | 0.28 | 0.21 | 0.25 |
| 2 | 0.445 | 0.41 | 0.38 | 0.41 |
| 3 | 0.62 | 0.64 | 0.61 | 0.62 |
| 4 | 0.82 | 0.89 | 0.85 | 0.85 |
| 5 | 0.98 | 0.95 | 0.99 | 0.97 |

Table 2 shows date from an example case in accordance with exemplary embodiments showing measurements of dissolved oxygen in water (%).

TABLE 2

| | Electrolysis of water | | | |
|---|---|---|---|---|
| | experiment | experiment | experiment | |
| | one | two | three | average value |
| 0 | 0 | 0.05 | 0 | 0.02 |
| 1 | 9.51 | 9.61 | 9.57 | 9.32 |
| 2 | 13.41 | 12.96 | 10.68 | 11.28 |
| 3 | 26.75 | 25.68 | 23.15 | 27.67 |
| 4 | 30.12 | 32.41 | 33.45 | 32.01 |
| 5 | 100 | 100 | 100 | 100 |

From Table 1 and Table 2 it can be seen that by the present invention, the ionization device and a corresponding mechanism ozone content in the tank can reach saturation, the ozone levels to 0.97 mg/L within 5 minutes. Ozone is soluble in water in a variety of ways, using agitation, one or more jets, a stirrer, or the like. An ionization means with respect to the tank 3 may be detachably attached and replaceable.

Referring back to FIGS. 1-4, 6, and 7, in some embodiments, a machine may comprise a rotatable accessories box 7, the accessory box 7 comprising a a rotatable door 4, or the like. In some embodiments, an accessory box 7 may be attached to a rotatable ultraviolet light source, or the like. Different functional heads or accessories may be placed in the machine's accessory box 7, and a UV light source may be installed in the accessory box for UV sterilization treatment or the like. As such, the user can be more at ease with the use of this product. In some embodiments, a machine may comprise a plurality of functional replacement joints 8 sequentially mounted in the box 7 and attachable to a handle 5. In some embodiments, a head 8 comprises a dental floss functional replacement joint replacement, joint replacement, and face cleansing flush joint replacement, or the like.

In some embodiments, a power source, such a s a lithium battery 9 may be included. In some embodiments, a machine may comprise a power source or battery cover 10. A lithium battery 9 may be mounted in the machine 7 and the battery cover 10 may be fixed. An ionizing member 3 and a water pump 11 may be powered by a battery.

In some embodiments, an electric toothbrush handle 6 may comprise may be removably mounted on a stand or charging port. An electric toothbrush holder charging port may be coupled with and equipped with an electric toothbrush. In some embodiments, a machine in accordance with exemplary embodiments may comprise a battery charger, and a rechargeable lithium battery 9. A charging process of the electric toothbrush in accordance with embodiments of the invention can be realized in the whole machine; that is, the charging of the whole machine and the electric toothbrush can be completed at the same time. In some embodiments, exhaust ozone gas heater/the ozone off-gas processing cartridge 1 may be detachably mounted on the tank 2.

In operation, to complete production of ozone water, the pump is connected to a driving force of the pump. A pump control chip through the PCB may be coupled with the machine to produce dental floss mode, facial flushing mode, different functions, cleansing flow mode, and/or the like, to achieve practical purposes. In exemplary embodiments, water may flow through the handle, or the like. In some embodiments, the handle may include a switch to control the flow of water flow to achieve the purpose of controlling the flow at any time; handle the water through the different accessories to replace the connector, the formation of scaling, rinse face, cleansing and other different functions of water.

Table 3 shows data related to a blue-oxygen water machine in accordance with embodiments of the present disclosure for oral care bacteria removal.

TABLE 3

| | Experimental | Experimental | Experimental | average |
|---|---|---|---|---|
| | group (a) | group (b) | group (three) | value |
| 5 | 98 | 98 | 98 | 100 |
| 10 | 100 | 100 | 100 | 100 |
| 15 | 100 | 100 | 100 | 100 |

Use of the oral care use blue water of oxygen machine in accordance with embodiments of the present invention 5-15 minutes can kill 100% of bacteria in the mouth.

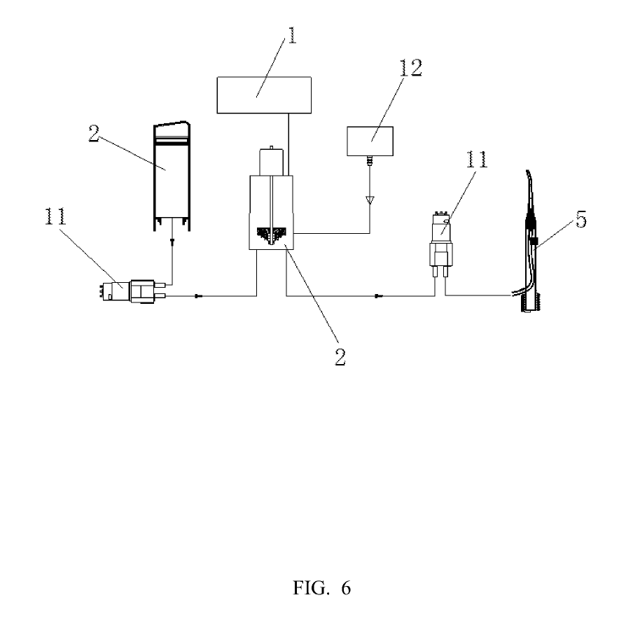

Referring to FIG. 6, a schematic diagram of a blue oxygen oral care system in accordance with embodiments of the present disclosure is shown. FIG. 6 an overall schematic structural diagram of an oral care blue oxygenated water machine of some embodiments of the invention is presented. A water tank may include and be equipped with a stirrer and an ozone generator. An ozone generator may be a separate device 12. In some embodiments ozone may be introduced in the water by the ozone generator and mixed with a stirrer, or the like.

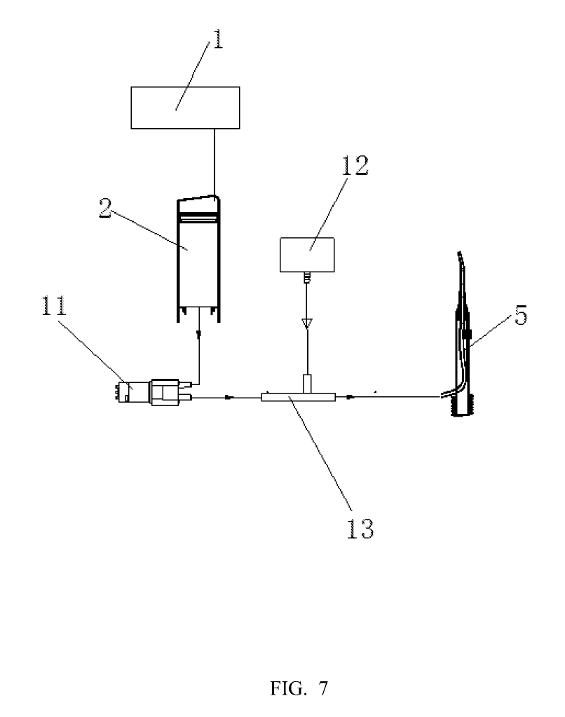

Referring to FIG. 7, a schematic diagram of a blue oxygen oral care system in accordance with embodiments of the present disclosure is shown. Overall schematic structural diagram of FIG. 7. In some embodiments, ozone may be mixed through an ejector 13, a jet, or the like.

Embodiments of the present disclosure may include many benefits. Some benefits may include efficient flossing of the teeth, removing residues between teeth, sterilization of an area and a mouth, processing excess ozone, blocking ozone emissions thereby reducing indoor air pollution, reduction of damage to the health of consumers, easy cleaning of the mouth and face, user-friendly design, and ease of transportation for traveling.

Hereinabove, the present invention has been described with reference to exemplary embodiments thereof. All exemplary embodiments and conditional illustrations disclosed in the present disclosure have been described to intend to assist in the understanding of the principle and the concept of the present invention by those skilled in the art to which the present invention pertains. Therefore, it will be understood by those skilled in the art to which the present invention pertains that the present invention may be implemented in modified forms without departing from the spirit and scope of the present invention.

Therefore, exemplary embodiments disclosed herein should be considered in an illustrative aspect rather than a restrictive aspect. The scope of the present invention should be defined by the claims rather than the above-mentioned description, and equivalents to the claims should be interpreted to fall within the present invention.

While the foregoing is directed to embodiments of the present invention, other and further embodiments of the invention may be devised without departing from the basic scope thereof. For example, although numerous embodiments having various features have been described herein, combinations of such various features in other combinations not discussed herein are contemplated within the scope of embodiments of the present invention.

What is claimed is:

1. An oral care machine comprising:
a tank for storing water;
an ozone generator for generating ozone, the ozone generator mounted in the tank, wherein generated ozone mixes with water stored in the tank;
a exhaust ozone gas heater and processing cartridge for treating exhaust gas of ozone generated by the machine when ozone is mixed with water, the processing cartridge mounted on the tank;
a water pump for transporting treated water; and
a handle for delivering the treated water to a desired location.

2. The oral care machine of claim 1, further comprising a dental floss replacement joint, the dental floss replacement joint comprising a dental floss tip including a water spout.

3. The oral care machine of claim 1, wherein the ozone generator is an ionizer.

4. The oral care machine of claim 1, wherein the ozone generator comprises:
a tank cover;
a tank lid seal comprising a plurality of filter holes, the tank lid seal having a lower end mounted on the tank cover;
an electrolyte sheet plate;
a tank cover shield including through holes, the tank cover shield mounted on the electrolyte sheet plate;
an electrolyte sheet comprising a plurality of filter holes, the electrolyte sheet mounted on the tank lid seal;
an electrolysis sheet mounted on the tank lid seal; and
a water receiving portion.

5. The oral care machine of claim 1, wherein the processing cartridge is detachably mounted on an upper end of the tank.

6. The oral care machine of claim 1, further comprising a conduit line for transporting water from the tank to the handle.

7. The oral care machine of claim 1, further comprising an accessories box, the box comprising at least one accessory attachable to the handle.

8. The oral care machine of claim 7, wherein the accessories box comprises an ultraviolet light source.

9. The oral care machine of claim 7, wherein the at least one accessory comprises a face cleaning attachment.

10. The oral care machine of claim 7, wherein the at least one accessory comprises a toothbrush attachment, wherein the handle is an electric toothbrush attached to the water pump, the handle providing ozone water to through the toothbrush.

11. The oral care machine of claim 1, further comprising:
a battery for providing power to the machine; and
a battery cover.

12. The oral care machine of claim 1, further comprising a stirring device for stirring and mixing water in the tank.

13. The oral care machine of claim 1, further comprising an ejector for mixing ozone generated by the ozone generator and water stored in the tank.

14. A machine comprising:
a tank for storing liquid;
an ozone generator for generating ozone, the ozone generator mounted in the tank, wherein generated ozone mixes with liquid stored in the tank;
a processing cartridge for treating exhaust gas of ozone generated by the machine when ozone is mixed with liquid, the processing cartridge mounted on the tank;
a pump for transporting treated liquid; and
a handle for delivering the treated liquid to a desired location.

15. The machine of claim 14, wherein the ozone generator is an ionizer.

16. The machine of claim 14, wherein the ozone generator comprises:
a tank cover;
a tank lid seal comprising a plurality of filter holes, the tank lid seal having a lower end mounted on the tank cover;
an electrolyte sheet plate;
a tank cover shield including through holes, the tank cover shield mounted on the electrolyte sheet plate;
an electrolyte sheet comprising a plurality of filter holes, the electrolyte sheet mounted on the tank lid seal;
an electrolysis sheet mounted on the tank lid seal; and
a liquid receiving portion.

17. The machine of claim 14, wherein the processing cartridge is mounted on an upper end of the tank.

18. The machine of claim 14, wherein the processing cartridge is detachably mounted to the tank.

19. The machine of claim 14, further comprising a stirring device for stirring and mixing liquid in the tank.

20. The machine of claim 14, further comprising an ejector for mixing ozone generated by the ozone generator and liquid stored in the tank.
